(19) United States
(12) Patent Application Publication
(10) Pub. No.: US 2025/0249952 A1
(43) Pub. Date: Aug. 7, 2025

(54) ACTUATOR UNIT FOR A STEERING SYSTEM OF A MOTOR VEHICLE AND STEERING SYSTEM FOR A MOTOR VEHICLE

(71) Applicants: thyssenkrupp Presta AG, Eschen (LI); thyssenkrupp AG, Essen (DE)

(72) Inventors: Botond HÁMORI, Budapest (HU); Imre SZEPESSY, Mauren (LI)

(73) Assignees: thyssenkrupp Presta AG, Eschen (LI); thyssenkrupp AG, Essen (DE)

(21) Appl. No.: 19/046,066

(22) Filed: Feb. 5, 2025

(30) Foreign Application Priority Data
Feb. 6, 2024 (BE) BE 2024/5079

(51) Int. Cl. B62D 5/04; B62D 5/00

(52) U.S. Cl. CPC B62D 5/046; B62D 5/001

(57) ABSTRACT

An actuator unit for a steering system of a motor vehicle comprises a control housing in which there is received an electrical control unit, by means of which a motorized drive unit which is configured with the control housing for mechanically driving an actuator element which extends along an actuator axis relative to the control housing can be controlled. In order to enable a compact construction type and more flexible application possibilities with little structural complexity, the control housing may have a recess which extends over a circumferential portion about the actuator axis.

### CROSS REFERENCE TO RELATED APPLICATION

This application is a U.S. Non-Provisional that claims priority to Belgian Patent Application No. BE 2024/5079, filed Feb. 6, 2024, the entire content of which is incorporated herein by reference.

### FIELD

The present disclosure relates to an actuator unit for a steering system of a motor vehicle.

### BACKGROUND

An electrical power steering system or a steer-by-wire steering system of a motor vehicle has at least one such actuator unit, the function of which involves converting an electrical control signal into a mechanical manipulated variable, for example, into a mechanical adjustment or the production of a force or a torque. In a steer-by-wire steering system, for example, an actuator unit may comprise an electromotive steering actuator which converts electrical steering control commands into a steering angle of steerable wheels, or a feedback actuator which can couple a motorized feedback torque into a manual steering input apparatus in order to simulate a mechanical feedback which is dependent on the travel situation from the steerable wheels and thereby to produce a realistic driving sensation.

An actuator unit of the type mentioned in the introduction has a control unit which is also referred to as an ECU (electronic control unit) and which comprises an electronic control circuit which is configured to receive control signals from the vehicle control unit and depending on them to control an electric motor of the drive unit of the actuator unit. In the generic construction type, the control unit is accommodated in a control housing which is arranged spatially as far as possible close to the motor. Thus, in the prior art, it is, for example, known from U.S. Pat. No. 8,063,594 B2 to construct the control housing together with the motor housing of the motor in an integrated manner.

In the actuator unit mentioned above, the motor shaft of the motor is guided axially out of the control housing, wherein an actuator element can be axially connected to the motor in terms of drive. As a result of the fact that the control unit is arranged beside the motor, however, a relatively large amount of structural space is taken up, and the possibilities for coupling an actuator element are limited. It is in particular not possible or possible only with a high degree of structural complexity to use the actuator unit for driving an actuator element which extends in the direction of an actuator axis and which, depending on the configuration and the specific application purpose, may be able to be displaced linearly in the direction of the actuator axis—such as, for example, the toothed rack of a rack-and-pinion steering—or may also be able to be rotatably driven about the actuator axis—such as, for example, with a feedback drive of a manually rotatable steering spindle of a steering column.

Thus a need exists to enable a compact construction and more flexible application possibilities with little structural complexity.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a schematic illustration of a steer-by-wire steering system,

FIG. 2 shows a schematic illustration of a motor vehicle having a steer-by-wire steering system,

FIG. 3 shows a perspective partial view of an actuator unit according to the invention,

FIG. 4 shows a schematically exploded illustration of the actuator unit according to FIG. 3.

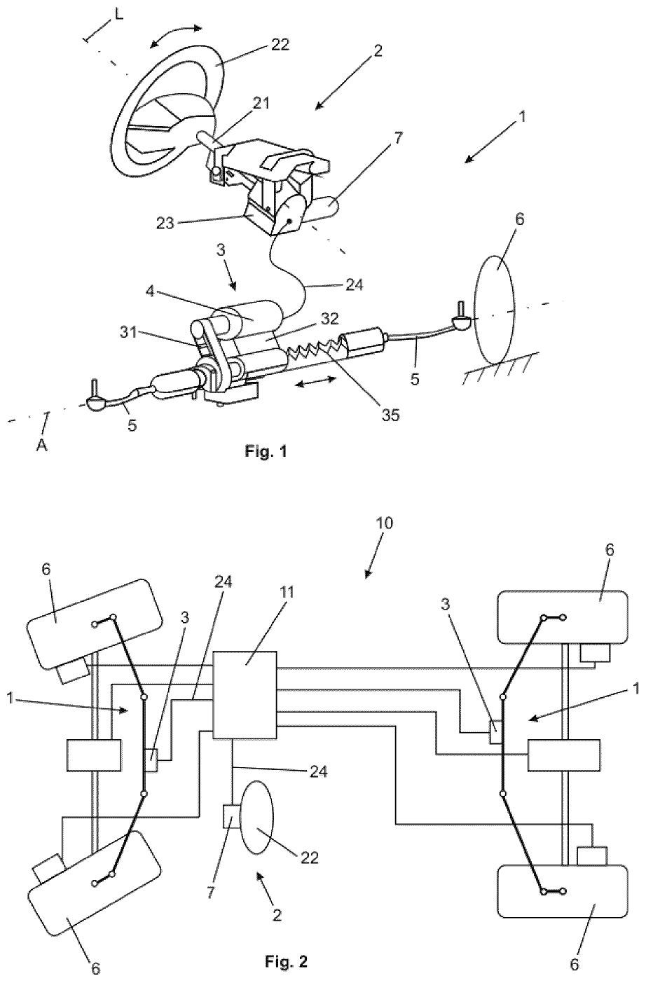

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The invention relates to an actuator unit for a steering system of a motor vehicle, comprising a control housing in which there is received an electrical control unit, by means of which a motorized drive unit which is configured with the control housing for mechanically driving an actuator element which extends along an actuator axis relative to the control housing can be controlled.

With an actuator unit for a steering system of a motor vehicle, comprising a control housing in which there is received an electrical control unit, by means of which a motorized drive unit which is configured with the control housing for mechanically driving an actuator element which extends along an actuator axis relative to the control housing can be controlled, there is provision according to the invention for the control housing to have a recess which extends over a circumferential portion about the actuator axis.

The recess is configured in a concave manner and formed in the control housing from the outer side transversely, that is to say in a radial direction with respect to the actuator axis. In this instance, the recess is configured to be radially open and surrounds or engages around the actuator axis over a circumferential part-range, for example, with a portion which extends substantially concentrically about the actuator axis. This may preferably be achieved by the recess having a substantially C-shaped or fork-like cross section. The open cross section may be configured axially with respect to the actuator axis, thus in the axis direction preferably in a substantially consistently continuous manner. The control housing can thereby engage around the actuator axis over an axial portion which corresponds to the thickness of the actuator housing when measured in the axial direction.

An advantage of the invention is that an actuator element which extends axially along the actuator axis may be able to be rotatably driven about the actuator axis by the drive unit so that it rotates within the recess according to the invention, for example, a steering shaft of a feedback actuator or a steering axle of a steering actuator. It is also possible for the actuator element to be able to be linearly displaced relative to the control housing axially in the direction of the actuator axis, for example, in a similar manner to the displacement of a toothed rack in the steering gear mechanism of a rack-and-pinion steering system. Flexible application possibilities for different applications in the steering system of motor vehicles can thereby be produced. Another advantage in this instance is that, as a result of the actuator element which is according to the invention practically embedded in the control housing in the region of the recess, an improved use of the structural space available is possible.

It is advantageous that the recess extends with respect to the actuator axis over a circumferential range of more than 90°. In this instance, the inner wall of the recess may surround an actuator element which extends along the actuator axis over at least a quarter circle. As a result of this, a significantly more compact construction type than with a box-like or cylindrical control housing as in the prior art is already possible.

Preferably, there may be provision for the recess to extend with respect to the actuator axis over a circumferential range of less than or equal to 180°. As a result of the engagement over a maximum of 180°, as a result of the fact that no undercuts are provided when viewed in the radial direction, a particularly simple and secure assembly is ensured. In this instance, advantageously at least half of the space which extends around the circumference of the actuator element can be used as structural space for the control unit.

It is also conceivable and possible for the recess to extend over a circumferential range of more than 180°. In this instance, it should be ensured that the radially outwardly open circumferential portion is sufficiently large for the control housing to be able to be positioned transversely, that is to say in a radial direction towards the actuator axis relative to the actuator element in the installation position. So that the assembly is also made possible, it is only necessary for the width of the opening of the recess to be greater than the diameter of the actuator element.

There may preferably be provision for the control unit to have a printed circuit board which extends in a planar manner transversely relative to the actuator axis. The printed circuit board, which is synonymously also referred to as a printed circuit board, has a preferably planar carrier plate of electrically insulating material, for example of epoxy resin or the like, to which electronic components which are connected to each other by means of strip conductors in order to form the control circuit of the control unit are fitted. In the arrangement according to the invention, the printed circuit board extends normally, that is to say perpendicularly to the actuator axis. The printed circuit board is arranged in the interior of the control housing.

In the above-mentioned embodiment, it is advantageous for the printed circuit board to be configured so as to be adapted to the recess of the control housing. The printed circuit board is received in the interior or the receiving space of the control housing, the shape and dimensions of which are determined by the outer shape of the control housing, wherein the inner space is delimited by a housing wall in the direction towards the recess. In the region of the recess which is formed in the control housing from the outer side in a concave manner, the interior accordingly has an indentation which protrudes transversely from the actuator axis. In order to make optimum use of the inner space which is available for receiving the control unit, it is advantageous for the printed circuit board to have a cavity which is adapted to the recess of the control housing. The cavity is accordingly adapted with respect to its shape and dimensions to the indentation which protrudes into the inner space. Preferably, there may be provision for the printed circuit board together with the control housing to engage around the actuator axis over a circumferential range. The advantage can thereby be afforded that the control unit makes optimum use of the structural space obtained by the recess according to the invention.

It is preferably possible for an electric motor of the drive unit to be fitted to the control housing. Preferably, the motor housing of the motor may be mechanically fixed to the control housing, for example, by means of a flange connection or the like.

There may be provision for the motor to have a motor axis which is arranged with spacing parallel with the actuator axis. A gear mechanism may preferably be arranged between the motor shaft which extends along the motor axis and the actuator element which extends along the actuator axis. This gear mechanism is configured to convert a rotation of the motor shaft into the required movement of the actuator element and may accordingly comprise a gear drive or belt drive, a spindle drive or other gear mechanism types. In this instance, it is advantageous that, as a result of the configuration according to the invention, in any case the required actuator movement can be produced.

There may be provision for the control unit to extend between the motor axis and the recess. Optimum use can thereby be made of the structural space.

It is possible for the actuator element to be able to be rotatably driven by the drive unit about the actuator axis. A rotation actuator can thereby be produced, for example, for the rotating drive of the steering shaft of a feedback actuator.

Alternatively, there may be provision for the actuator element to be able to be linearly displaced by the drive unit in the direction of the actuator axis. A linear actuator can thereby be produced, for example a steering actuator which is coupled by means of tie rods to steering knuckles, in a similar manner to a rack-and-pinion steering.

The invention further comprises a steering system for a motor vehicle, comprising at least one input unit for inputting steering commands, and an electrical actuator unit which has an electric drive unit which is connected to a control unit and which is constructed to convert electrical control signals into a mechanical movement of an actuator element, wherein there is provision according to the invention for the actuator unit to be configured in accordance with one of the embodiments described above, or combinations thereof.

It is, for example, possible for the actuator unit to have a steering actuator. The actuator unit may be operationally connected to a steering drive in order depending on control commands to produce a mechanical steering angle of steerable wheels. There may, for example, in a similar manner to the known operating principle of a rack-and-pinion steering be provision for an actuator element which can be linearly axially displaced to be articulated by means of tie rods to steering knuckles of steerable wheels of a front axle or rear axle. Alternatively, it is also conceivable and possible for a rotatably drivable actuator element to be coupled to the steering axle of a steerable wheel, for example, in order to produce a single-wheel steering.

It is possible for the actuator unit to be operationally connected to a steering input means. The steering input means may, for example, comprise a steering column which in order to input manual steering commands has a rotatably supported steering spindle to which a steering handle, such as a steering wheel or the like, is fitted. The rotation axis of the steering spindle corresponds to the actuator axis, that is to say the steering spindle is coupled to a rotatably drivable actuator element. The actuator unit serves to couple a feedback torque which is dependent on the travel situation into the steering spindle. Such a feedback actuator serves to produce a realistic driving sensation in steer-by-wire steering systems which have no mechanical connection between the manual steering handle and the wheels which are intended to be steered.

There may be provision for it to be in the form of a power steering or steer-by-wire steering system. The significant difference of these applications is that with an entirely steer-by-wire steering system there is no mechanical connection between a manual steering input means and the wheels which are intended to be steered. As already set out above, a significant advantage of the invention is that a simple structural adaptation to different functional and structural requirements can be carried out, for example, in order to produce steering actuators, or also feedback actuators or the like.

In the various figures, identical components are always given the same reference numerals and are therefore generally also only cited or mentioned once.

FIG. 1 schematically shows a steering system 1, which is in the form of a steer-by-wire steering system 1, as an overall view. This system comprises a steering column 2 in which a steering spindle 21 is rotatably supported about a longitudinal axis L. There is fitted thereto at the rear end with respect to the travel direction a steering wheel 22 which can be turned in order to input manual steering commands into the steering spindle 21, as indicated by the double-headed arrow.

The steering angle manually input into the steering spindle 21 and where applicable the manual steering torque can be detected by a rotation sensor unit 23 and converted into an electrical control signal which can be output via a control line 24.

An electromotive steering actuator 3 is connected to the control line 24 and comprises an electric motor 4 which can be controlled by the rotation sensor unit 23. Depending on the control signals, the motor 4 produces a drive torque.

The drive torque of the motor 4 is converted by means of a gear mechanism 31 into a longitudinal movement of an actuator rod 35 which is supported so as to be able to be longitudinally displaced relative to a control housing 32, for example, a threaded spindle or a toothed rack. This longitudinal movement which is indicated with the double-headed arrows is carried out axially in the direction of an actuator axis A and is in each case transmitted via a tie rod 5 to a steering knuckle of a wheel 6 which is intended to be steered.

There may further be provided a feedback actuator 7 which is connected to the steering column 2 and which is configured to couple a feedback torque into the steering spindle 21. To this end, in a similar manner to the steering actuator 3, an electric motor may be coupled to the steering spindle 21, wherein the actuator axis in this instance is provided by the longitudinal axis L.

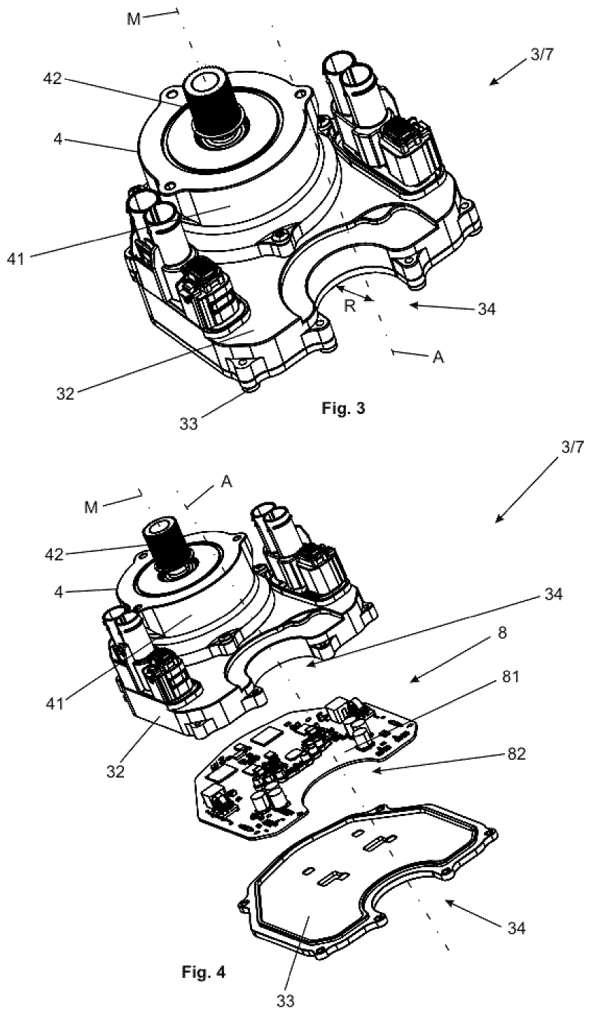

The actuators 3 and 7, that is to say the steering actuator(s) 3 and/or the feedback actuator 7, may be configured according to the invention. To this end, a structure shown in FIGS. 3 and 4 may be produced. The basic structure is explained below with reference to the actuator 3, wherein the functional elements can also be produced correspondingly with an actuator 7. In this instance, FIG. 3 shows the assembled state and FIG. 4 shows a schematically axially exploded illustration in the direction of the actuator axis A.

The actuator 3 has a control housing 32 which has an inner space which is open axially in a downward direction in FIGS. 3 and 4 and which is closed in a sealed manner by means of a cover 33.

The control housing 32 has according to the invention a recess 34 which is formed with respect to the actuator axis A in a concave manner, specifically approximately in a semi-circular manner with a radius R about the actuator axis A. The control housing 32 thereby engages around the actuator axis A over a circumferential portion of approximately 180°. In other words, it is configured in a substantially C-shaped manner.

The open cross section of the recess 34 extends axially in the direction of the actuator axis A in a consistent manner.

In the inner space of the control housing 32, there is arranged an electrical control unit 8 which is constructed on an extensive substantially planar printed circuit board 81 which extends transversely relative to the actuator axis A. As can be clearly seen in FIG. 4, the outer shape of the board 81 is adapted to the shape of the control housing 32 and has in the region of the recess 34 a corresponding cavity 82.

An electric motor 4 has a motor housing 41 which may be connected to the control housing 32, as in the example by means of a flange connection, and in which a motor shaft 42 is supported so as to be able to be rotatably driven about a motor axis M. This motor axis M extends with spacing parallel with the actuator axis A.

An actuator element according to the invention, for example, an actuator rod 35 or a steering spindle 21, may be arranged along the actuator axis A (or the longitudinal axis L) in the recess 34. Via a suitable gear mechanism 31, which is omitted in FIGS. 3 and 4 for greater clarity, the motor 4 can produce a rotational drive about the actuator axis A, for example, a rotating feedback drive of the steering spindle 21 about the longitudinal axis L, or also a linear drive in the direction of the actuator axis A, for example a linear displacement of the actuator rod 35.

As a result of the recess 34, a compact construction which can be used in a flexible manner is possible.

### LIST OF REFERENCE NUMERALS

1 Steering system
10 Motor vehicle
11 Central control unit
2 Steering column
21 Steering spindle
22 Steering wheel
23 Rotation sensor unit
24 Control line
3 Steering actuator
31 Gear mechanism
32 Control housing
33 Cover
34 Recess
35 Actuator rod
4 Motor
41 Motor housing
42 Motor shaft
5 Tie rod
6 Wheel
7 Feedback actuator
8 Control unit
81 Printed circuit board
L Longitudinal axis
M Motor axis
A Actuator axis
R Radius

1. An actuator unit for a steering system of a motor vehicle, comprising:
a control housing in which there is received an electrical control unit, by which a motorized drive unit which is configured with the control housing for mechanically driving an actuator element which extends along an actuator axis relative to the control housing can be controlled,
wherein the control housing has a recess which extends over a circumferential portion about the actuator axis.

2. The actuator unit according to claim 1, wherein the recess extends with respect to the actuator axis over a circumferential range of more than 90°.

3. The actuator unit according to claim 1, wherein the recess extends with respect to the actuator axis over a circumferential range of less than or equal to 180°.

4. The actuator unit according to claim 1, wherein the control unit has a printed circuit board which extends in a planar manner transversely relative to the actuator axis.

5. The actuator unit according to claim 4, wherein the printed circuit board is configured to be adapted to the recess of the control housing.

6. The actuator unit according to claim 1, wherein an electric motor of the drive unit is fitted to the control housing.

7. The actuator unit according to claim 6, wherein the motor has a motor axis which is arranged with spacing parallel with the actuator axis.

8. The actuator unit according to claim 6, wherein the control unit extends between the motor axis and the recess.

9. The actuator unit according to claim 1, wherein the actuator element can be rotatably driven by the drive unit about the actuator axis.

10. The actuator unit according to claim 1, wherein the actuator element can be linearly displaced by the drive unit in the direction of the actuator axis.

11. A steering system for a motor vehicle, comprising:
at least one input unit for inputting steering commands; and
an electrical actuator unit according to claim 1;
wherein the electrical actuator unit has an electric drive unit which is connected to a control unit and which is configured to convert electrical control signals into a mechanical movement of an actuator element.

12. The steering system according to claim 11, wherein the actuator unit has a steering actuator.

13. The steering system according to claim 11, wherein the actuator unit is operationally connected to a steering input means.

14. The steering system according to claim 11, wherein the steering system is a power steering or a steer-by-wire steering system.
